(19) United States
(12) Patent Application Publication
(10) Pub. No.: US 2023/0367169 A1
(43) Pub. Date: Nov. 16, 2023

(54) OPTICAL WAVEGUIDE ELEMENT, OPTICAL MODULATOR, OPTICAL MODULATION MODULE, AND OPTICAL TRANSMISSION DEVICE

(71) Applicant: SUMITOMO OSAKA CEMENT CO., LTD., Tokyo (JP)

(72) Inventors: Kosuke Okahashi, Tokyo (JP); Yu Kataoka, Tokyo (JP)

(21) Appl. No.: 18/246,559

(22) PCT Filed: Mar. 4, 2022
(86) PCT No.: PCT/JP2022/009413

§ 371 Date: Mar. 24, 2023

(30) Foreign Application Priority Data
Mar. 24, 2021 (JP) 2021-050410

(51) Int. Cl. G02F 1/225; G02F 1/21

(52) U.S. Cl. CPC G02F 1/225; G02F 1/212

(57) ABSTRACT

An optical waveguide device that can prevent fluctuations in electrical characteristics due to adhesion of foreign matter to electrodes without adversely affecting the degree of freedom in electrode design. The optical waveguide device includes a substrate, an optical waveguide formed on the substrate, an electrode for controlling a light wave propagating through the optical waveguide, and a first insulating layer disposed between two adjacent electrodes among the electrodes, in which the first insulating layer has a height from a surface of the substrate that is higher than heights of the two electrodes.

### TECHNICAL FIELD

The present invention relates to an optical waveguide device, an optical modulator, an optical modulation module, and an optical transmission apparatus.

### BACKGROUND ART

In a commercial optical fiber communication system, an optical modulator incorporating an optical modulation device as an optical waveguide device including an optical waveguide formed on a substrate and a control electrode for controlling a light wave propagating in the optical waveguide is often used. Among the optical modulation devices, an optical modulation device using LiNbO3 (hereinafter, also referred to as LN) having an electro-optic effect for a substrate can achieve wide-band optical modulation characteristics with less optical loss, so that it is widely used in optical fiber communication systems for high-frequency, large-capacity backbone optical transmission networks and metro networks.

As one measure for downsizing, widening the bandwidth, and saving power of such an optical modulation device, for example, an optical modulator using a rib-type optical waveguide or a ridge optical waveguide formed on the surface of a thin-film LN substrate (for example, a thickness of 20 μm or less) is being put into practical use (for example, Patent Literature No. 1). The rib-type optical waveguide or the ridge optical waveguide is a convex optical waveguide configured by forming a strip-shaped protruding portion on the thinned LN substrate. Thus, the interaction between the guided light propagating in the convex optical waveguide and the signal electric field generated in the substrate by the control electrode is strengthened (that is, the electric field efficiency is increased).

Further, such a convex optical waveguide can generally have a narrower waveguide width than a planar waveguide formed by diffusing metal (for example, titanium (Ti)) on the substrate plane. Therefore, in an optical waveguide device using a convex optical waveguide, the electric field efficiency can be further improved by narrowing the clearance between the control electrodes formed by sandwiching the convex optical waveguide in the plane of the substrate to several μm or less, and miniaturization, wide band, and power saving of the optical waveguide device are achieved.

One of the problems in such an optical waveguide device is that as a result of the narrowing of the clearance between the control electrodes as described above, an electrical bridge may be likely to form between the two control electrodes, and malfunction or failure may occur in the optical waveguide device due to, for example, foreign matter mixed in the housing containing the optical waveguide device, compared to the related art.

As a configuration for protecting an electrode formed on a substrate together with a convex optical waveguide, Patent Literature No. 2 discloses that a dielectric layer of polyimide, for example, having a thickness of 0.1 to 5 μm so as to cover a signal electrode formed on a ridge optical waveguide.

However, in the above-described configuration in the related art, the thickness of the dielectric layer formed is as thin as several μm, so that when metal foreign matter adheres to the signal electrode, the distribution of the electric field applied to the ridge optical waveguide and the capacitance between the signal electrodes may change, and the electrical characteristics and modulation characteristics of the optical modulation device may change.

It is also conceivable to form the dielectric layer thicker to reduce the characteristic variation due to the presence of metal foreign matter. However, in that case, the capacitance between the signal electrodes increases with the thickness of the dielectric layer, and there is a difficulty in matching the velocity of the electrical signal propagating through the signal electrode with the velocity of the light wave propagating through the ridge optical waveguide (so-called velocity matching), and reducing dielectric loss, so that the degree of freedom in electrode design is limited.

### CITATION LIST

### Patent Literature

[Patent Literature No. 1] International publication WO2018/031916 (A1)
[Patent Literature No. 2] Japanese Laid-open Patent Publication No. 2020-134874

### SUMMARY OF INVENTION

### Technical Problem

In view of the above background, there is a demand for an optical waveguide device that can prevent fluctuations in electrical characteristics due to adhesion of foreign matter to electrodes without adversely affecting the degree of freedom in electrode design.

### Solution to Problem

According to one aspect of the present invention, there is provided an optical waveguide device including: a substrate; an optical waveguide formed on the substrate; an electrode for controlling a light wave propagating through the optical waveguide; and a first insulating layer disposed between two adjacent electrodes among the electrodes, in which a height of the first insulating layer from a surface of the substrate is higher than heights of the two electrodes.

According to another aspect of the present invention, the two electrodes are disposed at positions sandwiching the optical waveguide in a plane of the substrate.

According to another aspect of the invention, a clearance between the two electrodes may be 15 μm or less.

According to another aspect of the present invention, a thickness of the first insulating layer from the surface of the substrate is 1 μm or more and 10 μm or less.

According to another aspect of the invention, a difference between the height of the first insulating layer and the heights of the two electrodes from the surface of the substrate is 5 μm or less.

According to still another aspect of the invention, the first insulating layer is resin.

According to another aspect of the invention, a second insulating layer covering a plurality of electrodes different from the two electrodes formed on the substrate is further provided.

According to another aspect of the present invention, the optical waveguide includes two Mach-Zehnder optical waveguides each including two parallel waveguides, and the plurality of electrodes covered by the second insulating layer form bias electrodes used for adjusting a bias point of the Mach-Zehnder optical waveguide.

According to another aspect of the invention, the second insulating layers are formed as individual insulating layers separated from each other covering the bias electrodes of the Mach-Zehnder optical waveguide.

According to still another aspect of the invention, the second insulating layer is resin.

Another aspect of the present invention is an optical modulator including: the optical waveguide device according to any one of the above aspects, which is an optical modulation device that modulates light; a housing that houses the optical waveguide device; an optical fiber that inputs light to the optical waveguide device; and an optical fiber that guides light output by the optical waveguide device to outside the housing.

Another aspect of the present invention is an optical modulation module including: the optical waveguide device according to any one of the above aspects, which is an optical modulation device that modulates light; a housing that houses the optical waveguide device; an optical fiber that inputs light to the optical waveguide device; an optical fiber that guides light output by the optical waveguide device to outside the housing; and a drive circuit that drives the optical waveguide device.

Another aspect of the present invention is an optical transmission apparatus including the optical modulator or the optical modulation module, and an electronic circuit that generates an electrical signal for causing the optical waveguide device to perform a modulation operation.

This specification includes all the contents of Japanese Patent Application No. 2021-050410 filed on Mar. 24, 2021.

### Advantageous Effects of Invention

According to the present invention, in an optical waveguide device, it is possible to prevent fluctuations in electrical characteristics due to adhesion of foreign matter to electrodes without adversely affecting the degree of freedom in electrode design.

### BRIEF DESCRIPTION OF DRAWINGS

FIG. 1 is a diagram showing a configuration of an optical modulation device according to a first embodiment of the present invention.

FIG. 2 is a cross-sectional view of the optical modulation device shown in FIG. 1 taken along line II-II.

FIG. 3 is a cross-sectional view of the optical modulation device shown in FIG. 1 taken along line III-III.

FIG. 4 is a cross-sectional view of the optical modulation device shown in FIG. 1 taken along line IV-IV.

FIG. 5 is a cross-sectional view of an optical modulation device according to a first modification example of the first embodiment.

FIG. 6 is a cross-sectional view of an optical modulation device according to a second modification example of the first embodiment.

FIG. 7 is a cross-sectional view of a working electrode of an optical modulation device according to a second embodiment of the present invention.

FIG. 8 is a cross-sectional view of a bias electrode of the optical modulation device according to the second embodiment.

FIG. 9 is a cross-sectional view of an optical modulation device according to a first modification example of the second embodiment.

FIG. 10 is a cross-sectional view of an optical modulation device according to a second modification example of the second embodiment.

FIG. 11 is a diagram illustrating a configuration of an optical modulator according to a third embodiment of the present invention.

FIG. 12 is a diagram illustrating a configuration of an optical modulation module according to a fourth embodiment of the present invention.

FIG. 13 is a diagram illustrating a configuration of an optical transmission apparatus according to a fifth embodiment of the present invention.

### DESCRIPTION OF EMBODIMENTS

Hereinafter, embodiments of the present invention will be described with reference to the drawings.

### First Embodiment

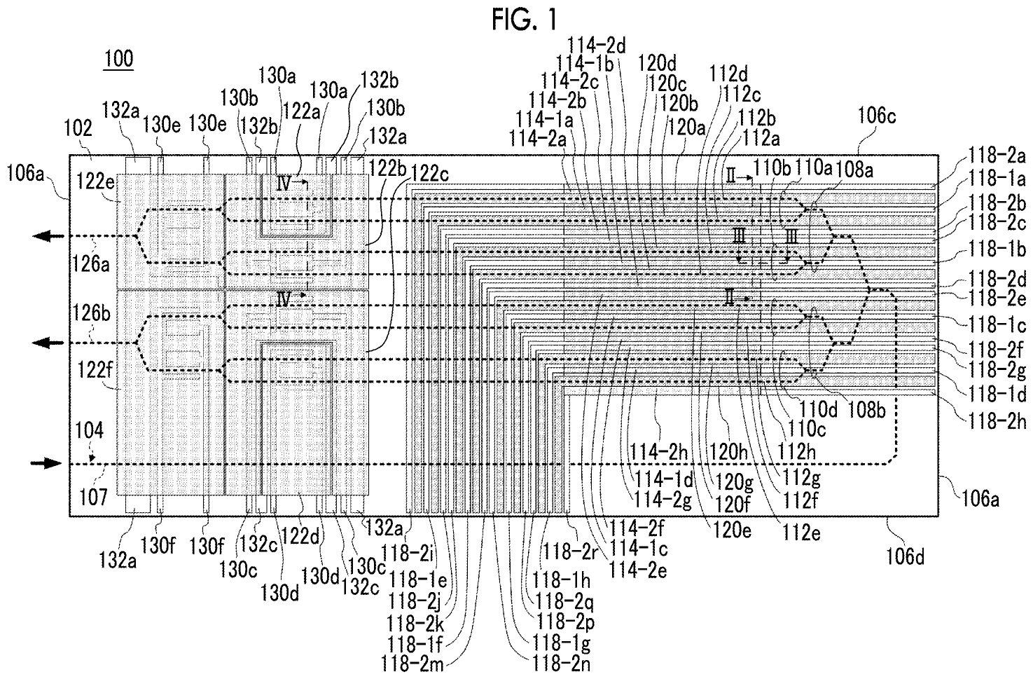

FIG. 1 is a diagram showing a configuration of an optical modulation device 100, which is an optical waveguide device according to a first embodiment of the present invention.

The optical modulation device 100 includes an optical waveguide 104 (shown thick dotted line) formed on a substrate 102. The substrate 102 is, for example, a thinned X-cut LN substrate having an electro-optic effect, which is processed to a thickness of 20 μm or less (for example, 2 μm). The optical waveguide 104 is a convex optical waveguide (for example, a rib-type optical waveguide or a ridge optical waveguide) including a strip-shaped extending protruding portion formed on the surface of the thinned substrate 102.

The substrate 102 is, for example, rectangular and has two shown left and right sides 106a and 106b extending in the shown vertical direction and facing each other, and shown upper and lower sides 106c and 106d extending in the shown left and right direction and facing each other.

The input light (an arrow pointing the shown right side) input to the input waveguide 107 of the optical waveguide 104 on the shown lower side of the shown left side 106a of the substrate 102 is folded back by 180 degrees in the light propagation direction and is branched into two light beams, and the light beams are QPSK-modulated by two nested Mach-Zehnder optical waveguides 108a and 108b, respectively. The two QPSK-modulated light beams are output from the shown upper side of the side 106a of the substrate 102 via the output waveguides 126a and 126b on the shown left edges, respectively (two arrows pointing the shown left side).

These two output light beams are output from the substrate 102, polarized and synthesized, for example, by a polarization beam combiner into one optical beam, and transmitted to a transmission optical fiber as a DP-QPSK-modulated optical signal.

The nested Mach-Zehnder optical waveguide 108a includes two Mach-Zehnder optical waveguides 110a and 110b. Further, the nested Mach-Zehnder optical waveguide 108b includes two Mach-Zehnder optical waveguides 110c and 110d.

The Mach-Zehnder optical waveguides 110a and 110b have two parallel waveguides 112a, 112b and 112c, 112d, respectively. Further, the Mach-Zehnder optical waveguides 110c and 110d have two parallel waveguides 112e, 112f and 112g, 112h, respectively.

For QPSK modulation in the nested Mach-Zehnder optical waveguide 108a, signal electrodes 114-1a and 114-1b to which high-frequency electrical signals for modulation are input are disposed between the two parallel waveguides 112a and 112b of the Mach-Zehnder optical waveguide 110a and between the two parallel waveguides 112c and 112d of the Mach-Zehnder optical waveguide 110b, respectively. Here, the high-frequency electrical signal means an electrical signal whose main component is, for example, a frequency of 10 kHz or higher.

Further, for QPSK modulation in the nested Mach-Zehnder optical waveguide 108b, signal electrodes 114-1c and 114-1d into which high-frequency electrical signals for modulation are input are disposed between the two parallel waveguides 112e and 112f of the Mach-Zehnder optical waveguide 110c, and between the two parallel waveguides 112g and 112h of the Mach-Zehnder optical waveguide 110d, respectively.

The signal electrode 114-1a configures a coplanar type transmission line together with the ground electrodes 114-2a and 114-2b facing each other across the parallel waveguides 112a and 112b, respectively, and the signal electrode 114-1b configures a coplanar type transmission line together with the ground electrodes 114-2c and 114-2d facing each other across the parallel waveguides 112c and 112d, respectively.

The signal electrode 114-1c configures a coplanar type transmission line together with the ground electrodes 114-2e and 114-2f facing each other across the parallel waveguides 112e and 112f, respectively, and the signal electrode 114-1d configures a coplanar type transmission line together with the ground electrodes 114-2g and 114-2h facing each other across the parallel waveguides 112g and 112h, respectively.

Hereinafter, the nested Mach-Zehnder optical waveguides 108a and 108b are collectively referred to as nested Mach-Zehnder optical waveguides 108. Further, the Mach-Zehnder optical waveguides 110a, 110b, 110c, and 110d are collectively referred to as Mach-Zehnder optical waveguides 110. Further, the parallel waveguides 112a, 112b, 112c, 112d, 112e, 112f, 112g, 112h are collectively referred to as parallel waveguides 112. Further, the signal electrodes 114-1a, 114-1b, 114-1c, and 114-1d are collectively referred to as signal electrodes 114-1. Further, the ground electrodes 114-2a, 114-2b, 114-2c, 114-2d, 114-2e, 114-2f, 114-2g, and 114-2h are collectively referred to as ground electrodes 114-2.

Further, the signal electrode 114-1 and the ground electrode 114-2 are collectively referred to as working electrodes 114. The signal electrode 114-1 and the ground electrode 114-2, which are the working electrodes 114, control the light wave propagating in the optical waveguide 104. Further, the signal electrode 114-1 and a ground electrode 114-2, which are working electrodes 114, are two adjacent electrodes sandwiching the parallel waveguide 112 of the optical waveguide 104 in the plane of the substrate 102.

In the present embodiment, each of the signal electrode 114-1 and the ground electrode 114-2, which are the working electrodes 114, is a two stage electrode, and is configured to be stepped thick as the distance from the parallel waveguide 112 sandwiched by the working electrodes increases.

The shown right edges of the signal electrodes 114-1a, 114-1b, 114-1c, and 114-1d are connected to the signal wiring electrodes 118-1a, 118-1b, 118-1c, and 118-1d, respectively. Further, the shown left edges of the signal electrodes 114-1a, 114-1b, 114-1c, and 114-1d are connected to the signal wiring electrodes 118-1e, 118-1f, 118-1g, and 118-1h, respectively.

The shown right edges of the ground electrodes 114-2a, 114-2b, 114-2c, 114-2d, 114-2e, 114-2f, 114-2g, and 114-2h are connected to the ground wiring electrodes 118-2a, 118-2b, 118-2c, 118-2d, 118-2e, 118-2f, 118-2g, and 118-2h, respectively. The shown left edges of the ground electrodes 114-2a, 114-2b, 114-2c, 114-2d, 114-2e, 114-2f, 114-2g, and 114-2h are connected to the ground wiring electrodes 118-2i, 118-2j, 118-2k, 118-2m, 118-2n, 118-2p, 118-2q, and 118-2r, respectively.

Thus, the signal wiring electrodes 118-1a, 118-1b, 118-1c, and 118-1d and the ground wiring electrodes 118-2a, 118-2b, 118-2c, 118-2d, 118-2e, 118-2f, 118-2g, and 118-2h respectively adjacent to these signal wiring electrodes configure a coplanar type transmission line. Similarly, the signal wiring electrodes 118-1e, 118-1f, 118-1g, and 118-1h and the ground wiring electrodes 118-2i, 118-2j, 118-2k, 118-2m, 118-2n, 118-2p, 118-2q, and 118-2r respectively adjacent to these signal wiring electrodes configure a coplanar type transmission line.

The signal wiring electrodes 118-1e, 118-1f, 118-1g, and 118-1h extending to the shown lower side 106d of the substrate 102 are terminated by a termination resistor (not shown) having a predetermined impedance outside the substrate 102.

Thus, the high-frequency electrical signal input from the signal wiring electrodes 118-1a, 118-1b, 118-1c, and 118-1d extending to the shown right side 106b of the substrate 102 becomes a traveling wave to propagate through the signal electrodes 114-1a, 114-1b, 114-1c, and 114-1d, and modulates the light wave propagating through the Mach-Zehnder optical waveguides 110a, 110b, 110c, and 110d, respectively.

Hereinafter, the signal wiring electrodes 118-1a, 118-1b, 118-1c, 118-1d, 118-1e, 118-1f, 118-1g, and 118-1h are collectively referred to as signal wiring electrodes 118-1. Further, the ground wiring electrodes 118-2a, 118-2b, 118-2c, 118-2d, 118-2e, 118-2f, 118-2g, 118-2h, 118-2i, 118-2j, 118-2k, 118-2m, 118-2n, 118-2p, 118-2q, and 118-2r are collectively referred to as ground wiring electrode 118-2. Further, the signal wiring electrode 118-1 and the ground wiring electrode 118-2 are collectively referred to as wiring electrodes 118. That is, the signal wiring electrode 118-1 and the ground wiring electrode 118-2 are wiring electrodes 118 connected to the working electrode 114.

The substrate 102 is provided with bias electrodes 130a, 130b, 130c, and 130d for adjusting the bias points of the Mach-Zehnder optical waveguides 110a, 110b, 110c, and 110d, and bias electrodes 130e and 130f for adjusting the bias points of the nested Mach-Zehnder optical waveguides 108a and 108b. Hereinafter, the bias electrodes 130a, 130b, 130c, 130d, 130e, and 130f are collectively referred to as bias electrodes 130.

In particular, in the optical modulation device 100 according to the present embodiment, each of the first insulating layers 120a, 120b, 120c, 120d, 120e, 120f, 120g and 120h is provided between the signal electrode 114-1 and the ground electrode 114-2, which are two adjacent working electrodes 114 sandwiching each of the parallel waveguides 112a, 112b, 112c, 112d, 112e, 112f, 112g, and 112h in the plane of the substrate 102. Here, the first insulating layers 120a, 120b, 120c, 120d, 120e, 120f, 120g, and 120h are collectively referred to as the first insulating layer 120.

Each of the first insulating layers 120 extends to rightward in the drawing along the adjacent working electrode 114 and the wiring electrode 118 to the side 106b of the substrate 102, and extends leftward and downward in the drawing to the side 106d of the substrate 102.

Here, the first insulating layer 120 has a height from the surface of the substrate 102 that is higher than the heights of the signal electrode 114-1 and the ground electrode 114-2, which are the two working electrodes 114 sandwiching the first insulating layer 120. Similarly, the first insulating layer 120 has the height from the surface of the substrate 102 that is higher than the heights of the signal wiring electrode 118-1 and the ground wiring electrode 118-2 that are the two wiring electrodes 118 sandwiching the first insulating layer 120.

The first insulating layer 120 is made of resin, which is a dielectric, for example. Such resins may be thermoplastic or thermosetting resins. In the present embodiment, the resin configuring the first insulating layer 120 is a photoresist containing a coupling agent (crosslinking agent), and is a so-called photosensitive permanent film that cures as the crosslinking reaction progresses with heat. However, this is only an example, and the first insulating layer 120 can be made of any resin such as polyamide resin, melamine resin, phenol resin, amino resin, or epoxy resin.

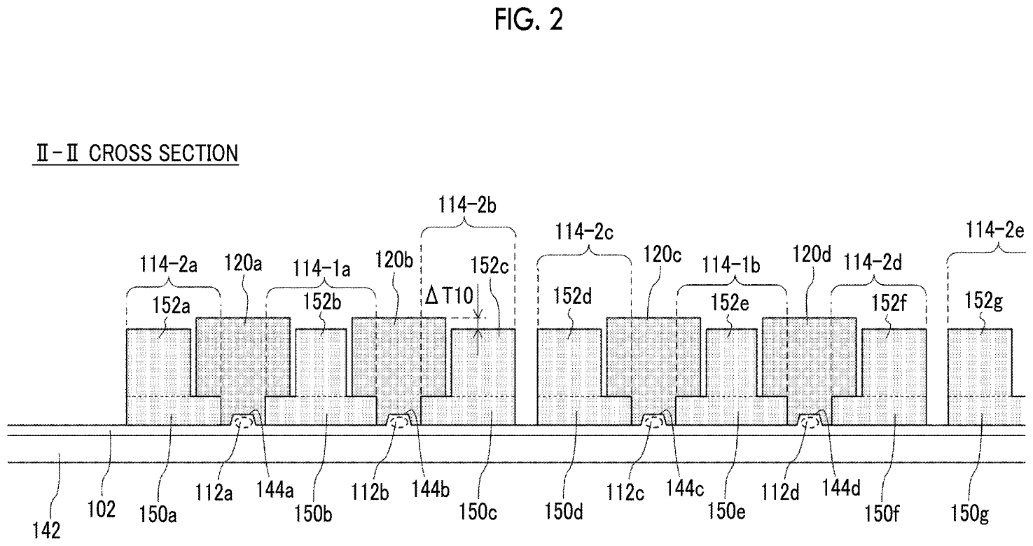

FIG. 2 is a cross-sectional view taken along line II-II in the optical modulation device 100 shown in FIG. 1. The back surface (shown lower surface) of the substrate 102 is supported and reinforced by the supporting plate 142. The supporting plate 142 is, for example, glass. The parallel waveguides 112a, 112b, 112c, and 112d are formed on the shown upper surface of the substrate 102, as convex optical waveguides by the protruding portions 144a, 144b, 144c, and 144d formed on the substrate 102, respectively. In addition, the shown four dotted-line ellipses schematically show light propagating through the parallel waveguides 112a, 112b, 112c, and 112d, which are convex optical waveguides.

The ground electrode 114-2a, the signal electrode 114-1a, and the ground electrode 114-2b are formed on the substrate 102 at positions sandwiching the parallel waveguides 112a and 112b in the plane of the substrate 102. Further, the ground electrode 114-2c, the signal electrode 114-1b, and the ground electrode 114-2d are formed at positions sandwiching the parallel waveguides 112c and 112d in the plane of the substrate 102. A ground electrode 114-2e is formed on the right side in the drawing of the ground electrode 114-2d.

In the present embodiment, the ground electrode 114-2a, the signal electrode 114-1a, the ground electrodes 114-2b and 114-2c, the signal electrode 114-1b, and the ground electrodes 114-2d, and 114-2e are two-stage electrodes composed of first-stage electrodes 150a, 150b, 150c, 150d, 150e, 150f, and 150g and second-stage electrodes 152a, 152b, 152c, 152d, 152e, 152f, and 152g, respectively.

The wiring electrodes 118 connected to the ground electrode 114-2a, the signal electrode 114-1a, and the ground electrode 114-2b, respectively, that is, the ground wiring electrode 118-2a, the signal wiring electrode 118-1a, and the ground wiring electrode 118-2b shown in FIG. 1 are respectively formed by the second stage electrodes 152a, 152b, and 152c of the ground electrode 114-2a, the signal electrode 114-1a, and the ground electrode 114-2b extending, for example, in the direction normal to the paper surface of FIG. 2. The same applies to the wiring electrode 118 connected to each of the ground electrode 114-2c, the signal electrode 114-1b, and the ground electrodes 114-2d and 114-2e.

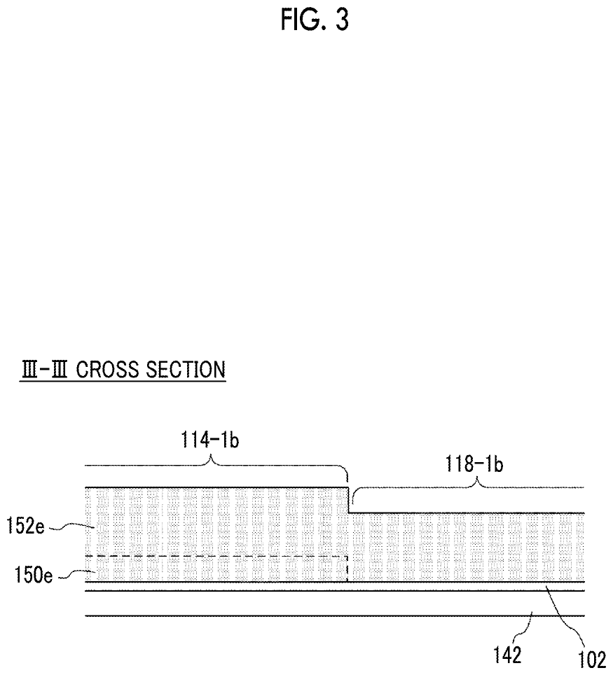

FIG. 3 is a diagram showing the connection between the signal electrode 114-1b and the signal wiring electrode 118-1b as an example, and is a cross-sectional view taken along line III-III in FIG. 1. A signal wiring electrode 118-1b connected to the signal electrode 114-1b is formed by the second stage electrode 152e of the signal electrode 114-1b extending rightward in the drawing.

Referring to FIG. 2, the first insulating layer 120a is disposed between the signal electrode 114-1a and the ground electrode 114-2a, which are two adjacent working electrodes 114 sandwiching the parallel waveguide 112a. Further, the first insulating layer 120b is disposed between a signal electrode 114-1a and a ground electrode 114-2b, which are two adjacent working electrodes 114 sandwiching the parallel waveguide 112b. Similarly, first Insulating layers 120c and 120d are respectively disposed between the signal electrode 114-1b and the ground electrode 114-2c and between the signal electrode 114-1b and the ground electrode 114-2d respectively sandwiching the parallel waveguides 112c and 112d.

Each of the first insulating layers 120a, 120b, 120c, and 120d has a height measured from the surface of the substrate 102 (that is, the upper surface in the drawing) that is higher than the heights of the signal electrode 114-1 and the ground electrode 114-2 that are the two electrodes sandwiching each of the first insulating layers.

The first insulating layers 120a, 120c, 120d, 120e, 120f, 120g, and 120h other than the first insulating layer 120b are similarly configured.

Hereinafter, the first insulating layers disposed between two adjacent working electrodes 114 sandwiching the parallel waveguide 112, including the first insulating layers 120a, 120b, 120c, and 120d, are collectively referred to as the first insulating layer 120.

In the optical modulation device 100 having the above configuration, between two adjacent working electrodes 114 sandwiching the parallel waveguide 112, the first insulating layer 120 having a height higher than the working electrodes 114 and the wiring electrodes 118 is formed. Therefore, in the optical modulation device 100, foreign matter falling toward these working electrodes 114 is blocked by the tall first insulating layer 120, which reduces the probability of adhering to and forming a bridge between the two working electrodes 114.

Further, the first insulating layers 120 need not be in contact with the entire surfaces of two adjacent working electrodes 114 (signal electrode 114-1 and/or ground electrode 114-2), as shown in FIG. 2. Therefore, the first insulating layer 120 does not significantly affect the capacitance between these two working electrodes 114, compared to the configuration described above in the related art. As a result, in the optical modulation device 100, fluctuations in electrical characteristics due to adhesion of foreign matter can be prevented without adversely affecting the degree of freedom in the design of the working electrode 114, which requires consideration of velocity matching between light waves and electrical signals and reduction of dielectric loss.

The effect of preventing adhesion of foreign matter to the working electrode 114 by the first insulating layer 120 as described above is great when the clearance between two adjacent working electrodes 114 is 15 μm or less. This is because the size of foreign matter present inside a housing (not shown) that houses the optical modulation device 100 is generally several tens of μm or less.

Further, in the present embodiment, since the first insulating layer 120 is made of resin, the first insulating layer 120 can be easily formed to a thickness (height) of about 10 μm, compared to the case where the first insulating layer 120 is made of an inorganic material such as SiO₂. Further, since such resins generally have a smaller Young's modulus than inorganic materials such as SiO₂, the stress applied from the first insulating layer 120 to the working electrode 114 and the substrate 102 is reduced, which ensures high long-term reliability.

Further, as shown in FIG. 2, in the present embodiment, the first insulating layer 120 is configured so as not to contact the second-stage electrodes 152 of the two adjacent working electrodes 114. Therefore, for example, when the first insulating layer 120 is made of a resin or the like having dielectric characteristics, the lines of electric force formed between the two working electrodes 114 during operation are denser between the first-stage electrodes 150 than between the second-stage electrodes 152 of the working electrodes 114. Therefore, in the optical modulation device 100, the strength of the electric field applied from the working electrode 114 to the parallel waveguide 112 is higher than in the case where the first insulating layer 120 is not provided, and the electric field efficiency is improved. As a result, the drive voltage of the optical modulation device 100 is reduced.

Note that the first insulating layer 120 can be formed on the substrate 102, for example, when the first insulating layer 120 is composed of a photosensitive permanent film that is a photoresist as in the present embodiment, by coating (spin-coating) the photoresist on the substrate 102 with a spinner and then patterning using ultraviolet rays. In this case, the height (that is, film thickness) of the first insulating layer 120 can be controlled by the rotational speed of the spinner. When the height of the first insulating layer 120 is controlled by the number of rotations of the spinner, the height of the first insulating layer is desirably in the range of 1 μm or more and 10 μm or less from the viewpoint of height controllability.

Further, the level difference ΔT10 (see FIG. 2) between the first insulating layer 120 and the working electrode 114 is preferably in the range of 5 μm or less, from the viewpoint of the height controllability of the first insulating layer 120. The lower limit of the level difference ΔT10 can be determined from the viewpoint of reducing, for example, the dielectric breakdown between the foreign matter adhered to the first insulating layer 120 and the working electrode 114, the capacitance fluctuation due to the foreign matter, and other impacts of the foreign matter on the electrical characteristics of the working electrode 114.

In addition, unlike the working electrode 114, in the case of electrodes which do not propagate high-frequency electrical signals, for example, the bias electrode 130, by covering the entirety with an insulating layer, it is possible to prevent fluctuations in electrical characteristics between the bias electrodes 130 due to adhesion of foreign matter. This is because the electrical characteristics of the bias electrodes 130, which do not propagate high-frequency electrical signals, are less susceptible to dielectric loss caused by the insulating layer covering the electrodes.

In the optical modulation device 100 shown in FIG. 1, in particular, for respective Mach-Zehnder optical waveguides 110 and the respective nested Mach-Zehnder optical waveguides 108, the bias electrodes 130 are covered with respective insulating layers separated from each other. Specifically, the bias electrodes 130a, 130b, 130c, and 130d for adjusting the respective bias points of the Mach-Zehnder optical waveguides 110a, 110b, 110c, and 110d are entirely covered with the respective second insulating layers 122a, 122b, 122c, and 122d separated from each other.

Further, the bias electrodes 130e and 130f for adjusting the respective bias points of nested Mach-Zehnder optical waveguides 108a and 108b are entirely covered with respective second insulating layers 122e and 122f separated from each other. Here, the second insulating layers 122a, 122b, 122c, 122d, 122e, and 122f are collectively referred to as the second insulating layer 122.

A ground electrode 132a is provided in the region on the substrate 102 where the bias electrode 130 is provided to divide the region of the nested Mach-Zehnder optical waveguide 108a and the region of the nested Mach-Zehnder optical waveguide 108b. A ground electrode 132b is also provided on the substrate 102 to divide the region where the bias electrode 130a of the Mach-Zehnder optical waveguide 110a is formed from the region where the bias electrode 130b of the Mach-Zehnder optical waveguide 110b is formed. Further, a ground electrode 132c is also provided on the substrate 102 to divide the region where the bias electrode 130c of the Mach-Zehnder optical waveguide 110c is formed from the region where the bias electrode 130d of the Mach-Zehnder optical waveguide 110d is formed.

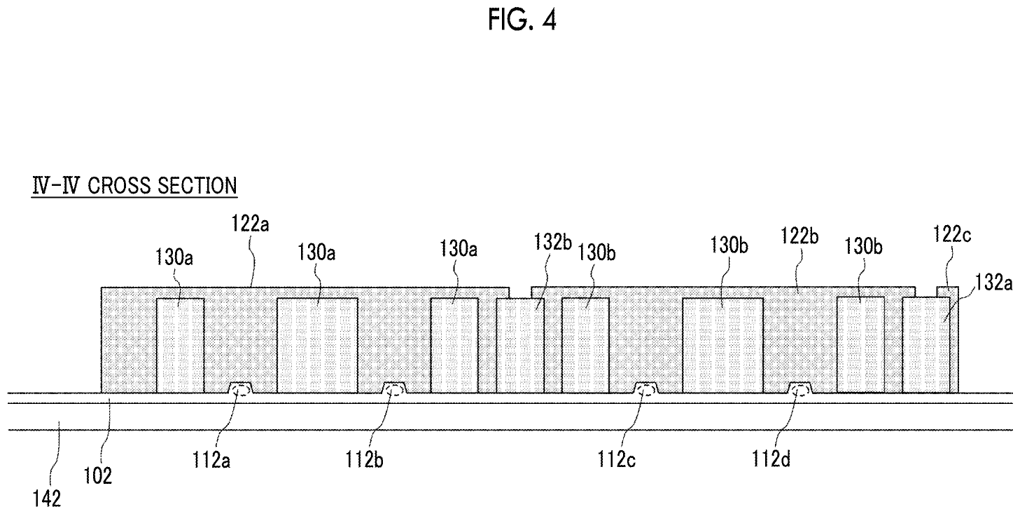

FIG. 4 is a cross-sectional view of the optical modulation device 100 shown in FIG. 1 taken along line IV-IV. Three bias electrodes 130a provided on the substrate 102 at positions sandwiching the parallel waveguides 112a and 112b are electrodes for adjusting the bias point of the Mach-Zehnder optical waveguide 110a, and are entirely covered with the second insulating layers 122a. Further, three bias electrodes 130b provided on the substrate 102 at positions sandwiching the parallel waveguides 112c and 112d are electrodes for adjusting the bias point of the Mach-Zehnder optical waveguide 110b, and are entirely covered with the second insulating layers 122b. The second insulating layer 122a and the second insulating layer 122b are separated from each other above the ground electrode 132 and configured as separate insulating layers.

As described above, the optical modulation device 100 includes a second insulating layer 122 covering a plurality of bias electrodes 130 different from the working electrode 114. Then, in particular, the second insulating layers 122 are formed as separate insulating layers separated from each other so as to cover the respective plurality of bias electrodes 130, for each Mach-Zehnder optical waveguide 110 and each nested Mach-Zehnder optical waveguide 108.

As a result, in the optical modulation device 100, interference of bias point adjustment operations between the bias electrodes 130 in the Mach-Zehnder optical waveguide 110 and the nested Mach-Zehnder optical waveguide 108 is prevented.

### First Modification Example of First Embodiment

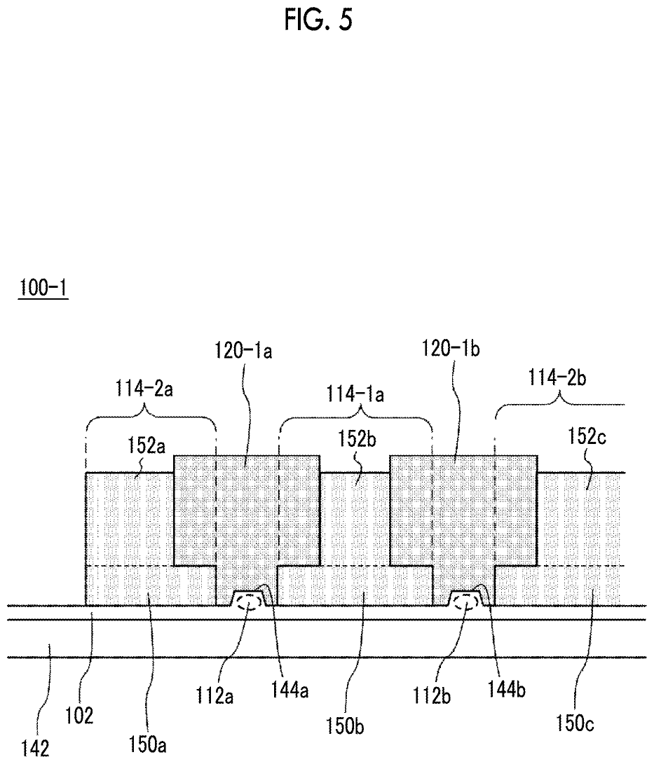

Next, a first modification example of the optical modulation device 100 according to the first embodiment will be described. FIG. 5 is a diagram showing the configuration of an optical modulation device 100-1 that is a first modification example of the optical modulation device 100. The optical modulation device 100-1 according to the first modification example has the same configuration as the optical modulation device 100, but the cross-sectional configuration of the first insulating layer disposed between the working electrodes 114 sandwiching the parallel waveguide 112 is different from the first insulating layer 120 shown in FIG. 2. FIG. 5 is a diagram corresponding to the left half portion of the II-II cross section of the optical modulation device 100 shown in FIG. 2. In FIG. 5, for the same components as those shown in FIG. 2, the same reference numerals as those shown in FIG. 2 are used, and the above description for FIG. 2 is incorporated. Further, since the planar configuration of the optical modulation device 100-1 is the same as the planar configuration of the optical modulation device 100 shown in FIG. 1, the above description of FIG. 1 is incorporated.

In FIG. 5, the first insulating layer 120-1a disposed between the ground electrode 114-2a and the signal electrode 114-1a, which are two adjacent working electrodes 114 sandwiching the parallel waveguide 112a, has the same configuration as the first insulating layer 120a shown in FIG. 2, but is different in that it is in contact with the entire side surfaces of the adjacent ground electrode 114-2a and signal electrode 114-1a. Similarly, the first insulating layer 120-1b disposed between the signal electrode 114-1a and the ground electrode 114-2b, which are two adjacent working electrodes 114 sandwiching the parallel waveguide 112b, has the same configuration as the first insulating layer 120b shown in FIG. 2, but differs in that it is in contact with the entire side surfaces of the adjacent signal electrode 114-1a and ground electrode 114-2b.

In the optical modulation device 100-1, the first insulating layers disposed between the two working electrodes 114 sandwiching the parallel waveguides 112 other than the parallel waveguides 112a and 112b are configured similarly to the first insulating layers 120-1a and 120-1b. Hereinafter, the first insulating layers 120-1a and 120-1b and other first insulating layers in the optical modulation device 100-1 having the same configuration as the first insulating layers 120-1a and 120-1b will be collectively referred to as the first insulating layer 120-1.

Since the first insulating layer 120-1 having the above configuration does not have a gap between the adjacent working electrodes 114, even when a minute foreign matter that enters the gap between the first insulating layer 120 and the working electrode 114 shown in FIG. 2 exists in the environment of the optical modulation device 100-1, it is possible to prevent the change in electrical characteristics of the working electrode 114 due to the foreign matter.

However, in the optical modulation device 100-1, the first insulating layer 120-1 is configured to be in contact with the entire side surfaces of the adjacent working electrodes 114, so that for example, when the first insulating layer 120-1 is made of a resin or the like having dielectric characteristics, the lines of electric force formed between these two working electrodes 114 during operation are dispersed throughout the first insulating layer 120-1. Therefore, the electric field applied from the working electrode 114 to the parallel waveguide 112 is weaker compared to the configuration of first insulating layer 120 shown in FIG. 2.

### Second Modification Example of First Embodiment

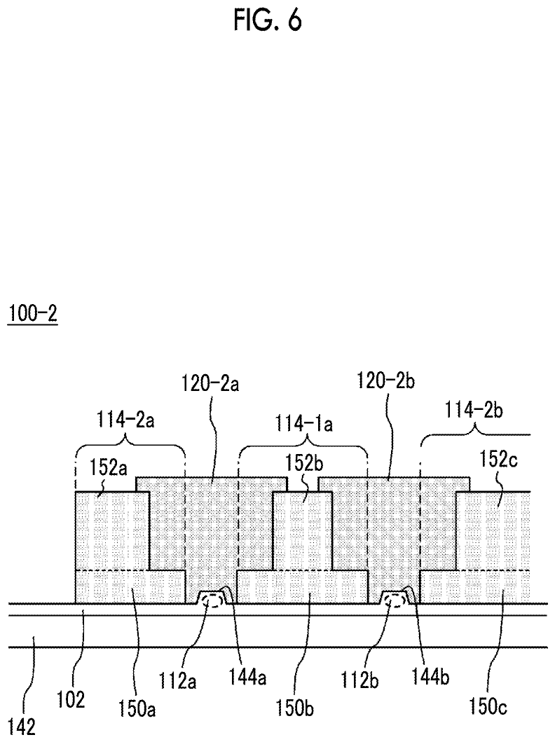

Next, a second modification example of the optical modulation device 100 according to the first embodiment will be described. FIG. 6 is a diagram showing the configuration of an optical modulation device 100-2 that is a second modification example of the optical modulation device 100. The optical modulation device 100-2 according to the second modification example has the same configuration as the optical modulation device 100, but the cross-sectional configuration of the first insulating layer disposed between the working electrodes 114 sandwiching the parallel waveguide 112 is different from the first insulating layer 120 shown in FIG. 2. FIG. 6 is a diagram corresponding to the left half portion of the II-II cross section of the optical modulation device 100 shown in FIG. 2. In FIG. 6, for the same components as those shown in FIG. 2, the same reference numerals as those shown in FIG. 2 are used, and the above description for FIG. 2 is incorporated. Further, since the planar configuration of the optical modulation device 100-2 is the same as the planar configuration of the optical modulation device 100 shown in FIG. 1, the above description of FIG. 1 is incorporated.

The first insulating layer 120-2a shown in FIG. 6 has the same configuration as the first insulating layer 120-1a shown in FIG. 5, but is different in that it is configured to partially cover the upper surface of each of the ground electrode 114-2a and the signal electrode 114-1a which are two adjacent working electrodes 114. Similarly, the first insulating layer 120-2b has the same configuration as the first insulating layer 120-1b shown in FIG. 5, but is different in that it is configured to partially cover the upper surface of each of the signal electrode 114-1a and the ground electrode 114-2b which are adjacent two working electrodes 114.

In the optical modulation device 100-2, the first insulating layers disposed between the two working electrodes 114 sandwiching the parallel waveguides 112 other than the parallel waveguides 112a and 112b are configured similarly to the first insulating layers 120-2a and 120-2b. Hereinafter, the first insulating layers 120-2a and 120-2b and other first insulating layers in the optical modulation device 100-2 having the same configuration as the first insulating layers 120-2a and 120-2b will be collectively referred to as the first insulating layer 120-2.

Since the first insulating layer 120-2 having the above configuration is formed to partially cover the upper surfaces of the adjacent working electrodes 114, the patterning of the first insulating layer 120-2 in the manufacturing process of the optical modulation device 100-2 is facilitated.

### Second Embodiment

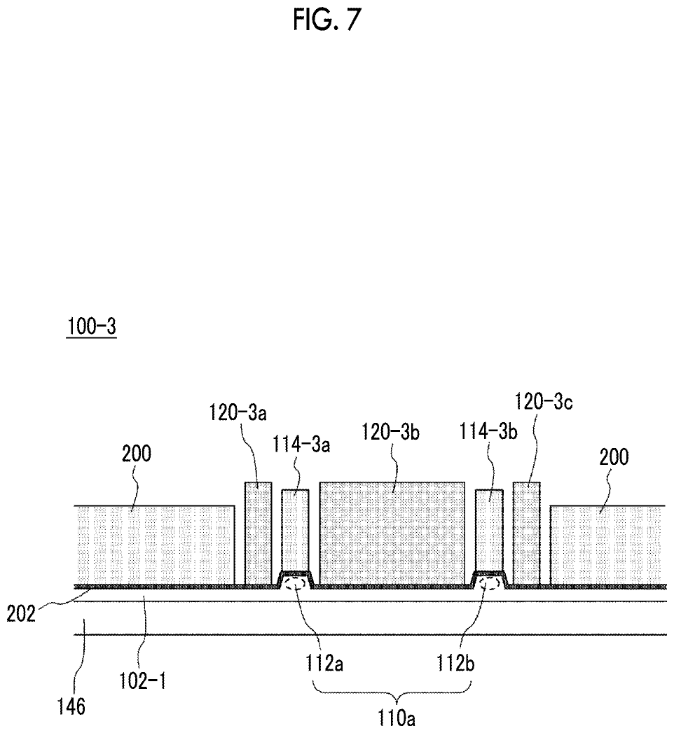

Next, a second embodiment of the present invention will be described. FIG. 7 is a diagram showing the configuration of an optical modulation device 100-3 according to the second embodiment, and is a diagram corresponding to the left half of the II-II cross section of the optical modulation device 100 shown in FIG. 2. The optical modulation device 100-3 has the same configuration as the optical modulation device 100, but is configured by a substrate 102-1 that is a Z-cut LN substrate instead of the substrate 102 that is the X-cut LN substrate. In FIG. 7, for the same components as those shown in FIG. 2, the same reference numerals as those shown in FIG. 2 are used, and the above description for FIG. 2 is incorporated.

The optical modulation device 100-3 has the same optical waveguide 104 as the optical modulation device 100. However, the optical modulation device 100-3 differs from the optical modulation device 100 in the configurations of the working electrode, the bias electrode, the first insulating layer, and the second insulating layer.

As will be apparent to those skilled in the art, the electrode for controlling the light wave of the optical waveguide formed on the Z-cut LN substrate is provided immediately above the optical waveguide, different from the electrode for controlling the light wave of the optical waveguide formed on the X-cut LN substrate. This is because the X-cut LN substrate has the maximum electro-optic coefficient in the direction along the substrate surface, whereas the Z-cut substrate has the maximum in the substrate thickness direction.

As will be apparent to those skilled in the art, in a Mach-Zehnder optical waveguide, it is common to apply electrical signals having phases opposite to each other to the electrodes formed immediately above the two parallel waveguides that form the waveguide. This is because the directions of increase and decrease of the refractive index generated in the two parallel waveguides are in opposite phases, so that the refractive index difference between the two parallel waveguides can be greatly changed, compared to the case where one electrode is fixed to the ground potential.

Therefore, in the optical modulation device 100-3 shown in FIG. 7, the working electrodes 114-3a and 114-3b for controlling the light waves propagating in the parallel waveguides 112a and 112b forming the Mach-Zehnder optical waveguide 110a are provided directly above the parallel waveguides 112a and 112b, respectively. In addition, in the present embodiment, a buffer layer 202 formed on the substrate 102-1 is interposed between the parallel waveguides 112a and 112b and the working electrodes 114-3a and 114-3b. The buffer layer 202 is made of, for example, SiO₂ and prevents possible optical absorption losses due to the presence of the working electrodes 114-3a and 114-3b in the parallel waveguides 112a and 112b.

Further, in the present embodiment, ground electrodes 200 are provided on the shown left side of the parallel waveguide 112a and the shown right side of the parallel waveguide 112b with the buffer layer 202 interposed therebetween.

Further, the first insulating layers 120-3a, 120-3b and 120-3c are provided between the ground electrode 200 and the working electrode 114-3a, between the working electrodes 114-3a and 114-3b, and between the working electrode 114-3b and the ground electrode 200, which are two adjacent electrodes, respectively. Each of the first insulating layers 120-3a, 120-3b, and 120-3c is configured such that the height from the surface of the substrate 102-1 is higher than the heights of the adjacent electrodes.

Therefore, even in the optical modulation device 100-3, similar to the optical modulation device 100 shown in FIG. 2, without significantly affecting the capacitance between the working electrodes 114-3a (thus without adversely affecting the degree of freedom in design of the working electrode 114), it is possible to prevent formation of a bridge between electrodes due to falling foreign matter.

In addition, in the optical modulation device 100-3, even in the other Mach-Zehnder optical waveguides 110b, 110c, and 110d, working electrodes, a ground electrode, and first insulating layers are formed, similar to the working electrodes 114-3a and 114-3b, the ground electrode 200, and the first insulating layers 120-3a and 120-3b of the Mach-Zehnder optical waveguide 110a shown in FIG. 7.

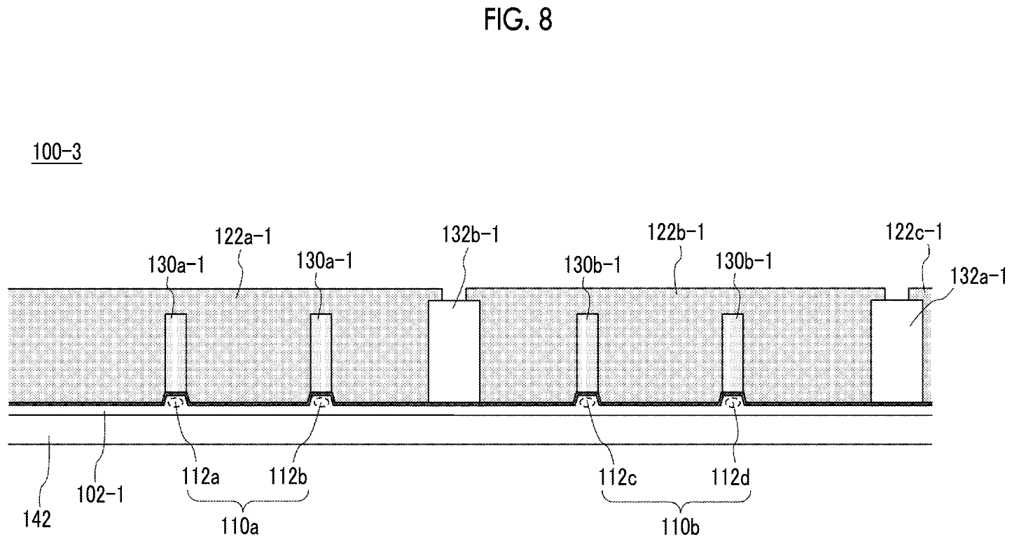

FIG. 8 is a diagram showing the configuration of the bias electrode portion of the optical modulation device 100-3 according to the second embodiment. FIG. 8 is a diagram corresponding to the IV-IV cross-sectional view of the optical modulation device 100 shown in FIG. 4. In FIG. 8, for the same components as those shown in FIG. 4, the same reference numerals as those shown in FIG. 4 are used, and the above description for FIG. 4 is incorporated.

Similar to the working electrodes 114-3a and 114-3b shown in FIG. 7, the bias electrode 130a-1 is formed directly above the parallel waveguides 112a and 112b forming the Mach-Zehnder optical waveguide 110a with the buffer layer 202 interposed therebetween. Further, the bias electrode 130a-2 is formed directly above the parallel waveguides 112c and 112d forming the Mach-Zehnder optical waveguide 110b with the buffer layer 202 interposed therebetween.

These bias electrodes 130a-1 and 130a-2 are covered with respective second insulating layers 122a-1 and 122a-2 separated from each other, for each Mach-Zehnder optical waveguide 110. In the present embodiment, the second insulating layers 122a-1 and 122a-2 are separated from each other above the ground electrode 132b-1 provided on the substrate 102-1.

Further, the second insulating layer 122b-1 covering the bias electrode 130b-1 of the Mach-Zehnder optical waveguide 110b is separated from the second insulating layer 122c-1 covering the bias electrode of the Mach-Zehnder optical waveguide 110c present on the right side in the drawing above the ground electrode 132a-1 provided on the substrate 102-1.

In addition, in the optical modulation device 100-3, in other Mach-Zehnder optical waveguides 110c and 110d and nested Mach-Zehnder optical waveguides 108a and 108b, a bias electrode, a ground electrode, and a second insulating layer are formed similar to the bias electrodes 130a-1 and 130a-2, the ground electrodes 132b-1 and 132a-1, and the second insulating layers 122a-1 and 122b-1 in the Mach-Zehnder optical waveguides 110a and 110b shown in FIG. 8.

Thus, in the optical modulation device 100-3, similar to the optical modulation device 100, interference of bias point adjustment operations by bias electrodes is prevented between the Mach-Zehnder optical waveguide 110 and the nested Mach-Zehnder optical waveguide 108.

### First Modification Example of Second Embodiment

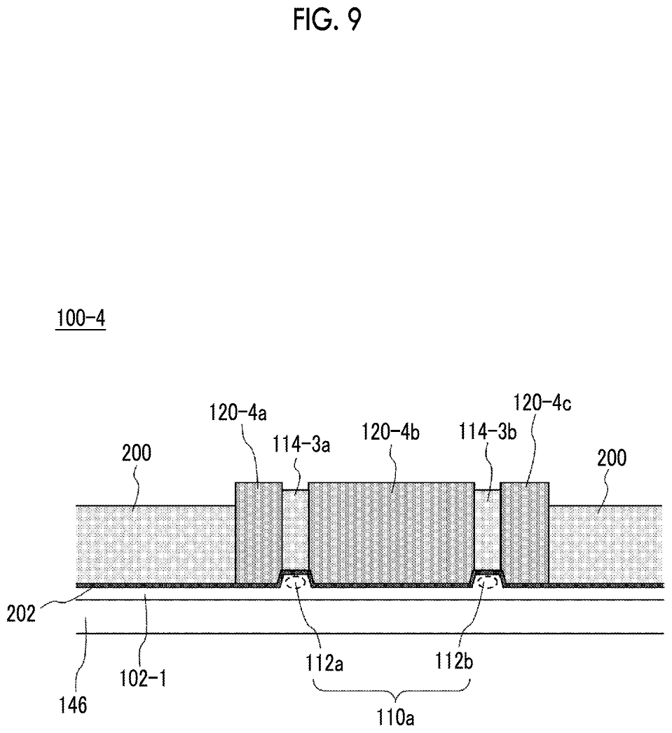

Next, a first modification example of the optical modulation device 100-3 according to the second embodiment will be described. FIG. 9 is a diagram showing the configuration of an optical modulation device 100-4 that is the first modification example of the optical modulation device 100-3, and is a diagram corresponding to the cross-sectional view of the optical modulation device 100-3 shown in FIG. 8. In FIG. 9, for the same components as those shown in FIG. 8, the same reference numerals as those shown in FIG. 8 are used, and the above description for FIG. 8 is incorporated. Further, since the planar configuration of the optical modulation device 100-4 is the same as the planar configuration of the optical modulation device 100 shown in FIG. 1, the above description of FIG. 1 is incorporated.

The optical modulation device 100-4 shown in FIG. 9 has the same configuration as the optical modulation device 100-3 shown in FIG. 7, but differs in having first insulating layers 120-4a, 120-4b, and 120-4c, instead of the first insulating layers 120-3a, 120-3b, and 120-3c. The first insulating layers 120-4a, 120-4b, and 120-4c have the same configuration as the first insulating layers 120-3a, 120-3b, and 120-3c, but are different in that being in contact with the entire side surfaces of adjacent electrodes, similar to the first insulating layers 120-1a and 120-1b shown in FIG. 5. That is, the first insulating layer 120-4a is in contact with the entire side surfaces of the adjacent ground electrode 200 and working electrode 114-3a. The first insulating layers 120-4b and 120-4c are in contact with the entire side surfaces of the working electrodes 114-3a and 114-3b and the entire side surfaces of the working electrode 114-3b and the ground electrode 200, respectively.

Thus, in the optical modulation device 100-4, similar to the optical modulation device 100-1 shown in FIG. 5, even when a minute foreign matter exists in the environment of the optical modulation device 100-4, it is possible to prevent the change in electrical characteristics of the working electrodes 114-3a and 114-3b due to the foreign matter.

### Second Modification Example of Second Embodiment

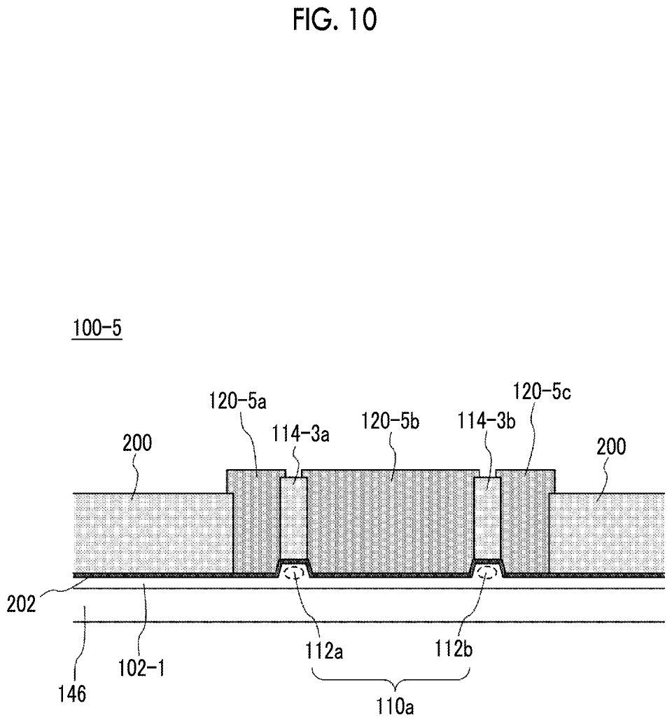

Next, a second modification example of the optical modulation device 100-3 according to the second embodiment will be described. FIG. 10 is a diagram showing the configuration of an optical modulation device 100-5 that is the second modification example of the optical modulation device 100-3, and is a diagram corresponding to the cross-sectional view of the optical modulation device 100-3 shown in FIG. 8. In FIG. 10, for the same components as those shown in FIG. 8, the same reference numerals as those shown in FIG. 8 are used, and the above description for FIG. 8 is incorporated. Further, since the planar configuration of the optical modulation device 100-5 is the same as the planar configuration of the optical modulation device 100 shown in FIG. 1, the above description of FIG. 1 is incorporated.

The optical modulation device 100-5 shown in FIG. 10 has the same configuration as the optical modulation device 100-3 shown in FIG. 7, but differs in having first insulating layers 120-5a, 120-5b, and 120-5c, instead of the first insulating layers 120-3a, 120-3b, and 120-3c. The first insulating layers 120-5a, 120-5b, and 120-5c have the same configuration as the first insulating layers 120-3a, 120-3b, and 120-3c, but they are different in that they are configured so as to partially cover the upper surfaces of the adjacent electrodes, similar to the first insulating layers 120-2a and 120-2b shown in FIG. 6.

In the optical modulation device 100-5 having the above configuration, similar to the optical modulation device 100-2 shown in FIG. 6, patterning of the first insulating layers 120-5a, 120-5b, and 120-5c in the manufacturing process of the optical modulation device 100-5 is facilitated.

### Third Embodiment

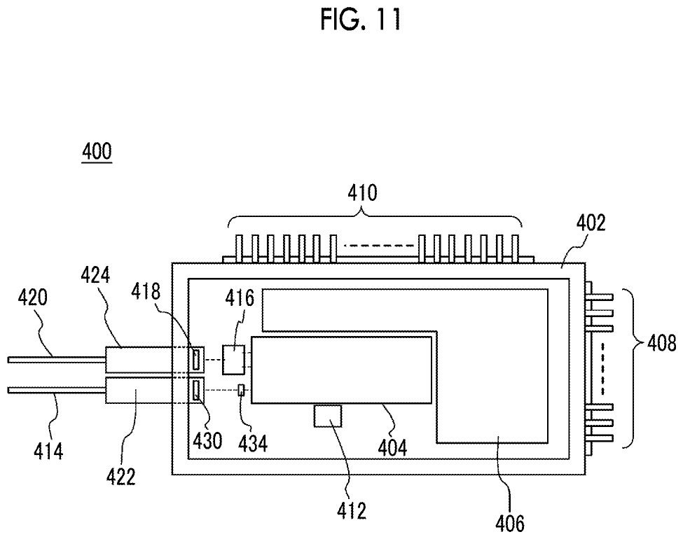

Next, a third embodiment of the present invention will be described. The present embodiment is an optical modulator using anyone of the above-described optical modulation devices. FIG. 11 is a diagram showing the configuration of an optical modulator 400 according to the third embodiment. The optical modulator 400 includes a housing 402, an optical modulation device 404 housed in the housing 402, and a relay substrate 406. The optical modulation device 404 is any one of the above-described optical modulation devices 100, 100-1, 100-2, 100-3, 100-4, and 100-5. Finally, a cover (not shown), which is a plate body, is fixed to the opening of the housing 402, and the inside of the housing 402 is hermetically sealed.

The optical modulator 400 has signal pins 408 for inputting a high-frequency electrical signal used for modulation of the optical modulation device 404, and signal pins 410 for inputting an electrical signal used for adjusting the operating point of the optical modulation device 404.

Further, the optical modulator 400 has an input optical fiber 414 for inputting light into the housing 402 and an output optical fiber 420 for guiding the light modulated by the optical modulation device 404 to the outside of the housing 402, on the same surface of the housing 402 (in the present embodiment, the surface on the left side).

Here, the input optical fiber 414 and the output optical fiber 420 are fixed to the housing 402 via the supports 422 and 424 which are fixing members, respectively. The light input from the input optical fiber 414 is collimated by the lens 430 disposed in the support 422 and then input to the optical modulation device 404 via the lens 434. However, this is only an example, and the light may be input to the optical modulation device 404, based on the related art, for example, by introducing the input optical fiber 414 into the housing 402 via the support 422, and connecting the end face of the introduced input optical fiber 414 to the end face of the substrate 102 of the optical modulation device 404.

The light output from the optical modulation device 404 is coupled to the output optical fiber 420 via the optical unit 416 and the lens 418 disposed on the support 424. The optical unit 416 may include a polarization beam combiner that combines two modulated light output from the optical modulation device 404 into a single beam.

The relay substrate 406 relays the high-frequency electrical signal input from the signal pins 408 and the electrical signal for adjusting an operating point (bias point) input from the signal pins 410 to the optical modulation device 404, according to a conductor pattern (not shown) formed on the relay substrate 406. The conductor pattern on the relay substrate 406 is connected to a pad (described later) configuring one end of the electrode of the optical modulation device 404 by wire bonding or the like, for example. Further, the optical modulator 400 includes a terminator 412 having a predetermined impedance in the housing 402.

Since the optical modulator 400 having the above configuration uses the optical modulation device 404 which is one of the optical modulation devices 100, 100-1, 100-2, 100-3, 100-4, and 100-5 described above, it is possible to achieve the optical modulator 400 with good characteristics and high reliability by preventing fluctuations in electrical characteristics due to adhesion of foreign matter in the housing 402 while securing the degree of freedom in designing the working electrode 114 and the like.

### Fourth Embodiment

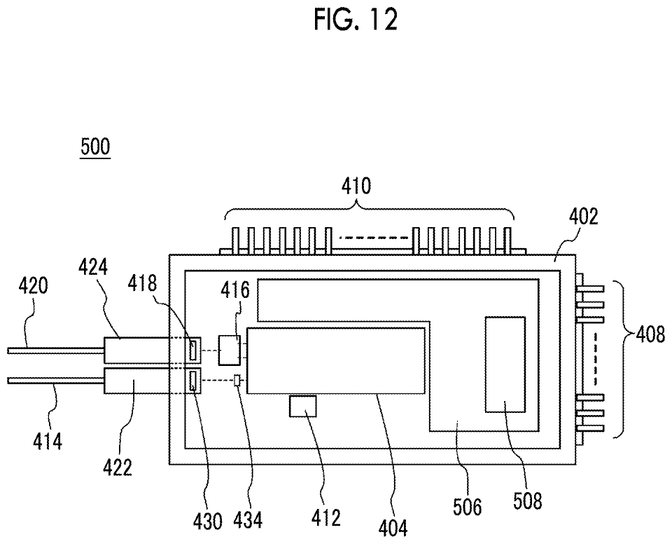

Next, a fourth embodiment of the present invention will be described. The present embodiment is an optical modulation module 500 using the optical modulation device according to any one of the above-described embodiments or modification examples. FIG. 12 is a diagram showing the configuration of an optical modulation module 500 according to the present embodiment. In FIG. 12, for the same components as in the optical modulator 400 according to the third embodiment shown in FIG. 11, the same reference numerals as the reference numerals shown in FIG. 11 are used, and the above description for FIG. 11 is incorporated.

The optical modulation module 500 has the same configuration as the optical modulator 400 shown in FIG. 11, but differs from the optical modulator 400 in that the optical modulation module 500 has a circuit substrate 506 instead of the relay substrate 406. The circuit substrate 506 includes a drive circuit 508. The drive circuit 508 generates a high-frequency electrical signal for driving the optical modulation device 404 based on, for example, a modulation signal supplied from the outside via the signal pins 408, and outputs the generated high-frequency electrical signal to the optical modulation device 404.

Since the optical modulation module 500 having the above configuration uses the optical modulation device 404 which is one of the optical modulation devices 100, 100-1, 100-2, 100-3, 100-4, and 100-5 described above, similar to the optical modulator 400, it is possible to achieve the optical modulation module 500 with good characteristics and high reliability by preventing fluctuations in electrical characteristics due to adhesion of foreign matter in the housing 402 while securing the degree of freedom in designing the working electrode 114 and the like.

### Fifth Embodiment

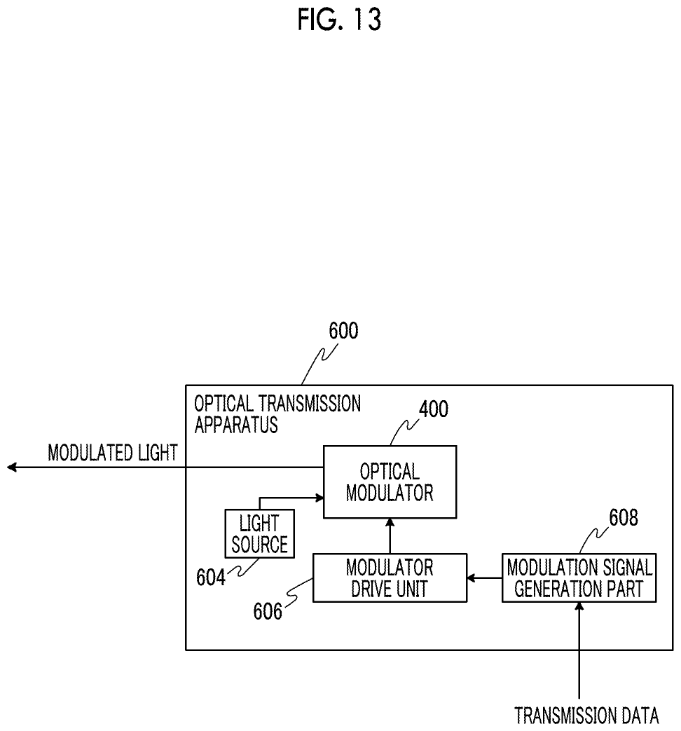

Next, a fifth embodiment of the present invention will be described. The present embodiment is an optical transmission apparatus 600 equipped with the optical modulator 400 according to the third embodiment. FIG. 13 is a diagram showing a configuration of an optical transmission apparatus 600 according to the present embodiment. The optical transmission apparatus 600 includes an optical modulator 400, a light source 604 that inputs light to the optical modulator 400, a modulator drive unit 606, and a modulation signal generation part 608. The above-described optical modulation module 500 can also be used instead of the optical modulator 400 and the modulator drive unit 606.

The modulation signal generation part 608 is an electronic circuit that generates an electrical signal for causing the optical modulator 400 to perform a modulation operation, which generates, based on transmission data given from the outside, a modulation signal which is a high-frequency signal for causing the optical modulator 400 to perform an optical modulation operation according to the modulation data, and outputs the modulation signal to the modulator drive unit 606.

The modulator drive unit 606 amplifies the modulation signal input from the modulation signal generation part 608, and outputs a high-frequency electrical signal for driving a signal electrode such as the optical modulation device 404 included in the optical modulator 400. As described above, instead of the optical modulator 400 and the modulator drive unit 606, for example, the optical modulation module 500 provided with a drive circuit 508 including a circuit corresponding to the modulator drive unit 606 inside the housing 402 can also be used.

The high-frequency electrical signal is input to the signal pins 408 of the optical modulator 400 to drive the optical modulation device 100 and the like. Thus, the light output from the light source 604 is modulated by the optical modulator 400, becomes modulated light, and is output from the optical transmission apparatus 600.

Since the optical transmission apparatus 600 having the above configuration is configured by using the optical modulation device 404 which is one of the optical modulation devices 100, 100-1, 100-2, 100-3, 100-4, and 100-5 described above, similar to the optical modulator 400 and the optical modulation module 500, it is possible to implement optical transmission with good characteristics and high reliability by preventing fluctuations in electrical characteristics due to adhesion of foreign matter in the housing 402 while securing the degree of freedom in designing the working electrode 114 and the like.

The present invention is not limited to the configuration of the above embodiment, and can be implemented in various embodiments without departing from the gist thereof.

For example, in the optical modulation device 100 shown in FIG. 1, there is a portion of the substrate 102 on which no electrode and optical waveguide 104 are formed, but all or a part of such a portion may be covered with a ground pattern, according to the related art.

As described above, the optical modulation device 100, which is the optical waveguide device according to the above-described embodiment, includes the substrate 102, the optical waveguide 104 formed on the substrate 102, and the working electrode 114 for controlling a light wave propagating in the optical waveguide 104. Further, the optical modulation device 100 includes a first insulating layer 120 disposed between two adjacent working electrodes 114. The height of the first insulating layer 120 from the surface of the substrate 102 is higher than the heights of the two working electrodes 114.

According to this configuration, the probability that foreign matter present in the environment of the optical modulation device 100 adheres between the two working electrodes 114 and form a bridge is reduced, so that the reliability of the optical modulation device 100 can be improved. On the other hand, the first insulating layer 120 does not need to be in contact with the entire surfaces of the adjacent working electrodes 114, so that the capacitance between these two working electrodes 114 is not significantly affected, and the degree of freedom in design of the working electrode 114 is not limited.

In addition, the two working electrodes 114 are disposed at positions sandwiching the parallel waveguide 112, which is a part of the optical waveguide 104, in the plane of the substrate 102, for example. According to this configuration, the electric field efficiency of the parallel waveguide 112 can be improved, when the first insulating layer 120 between the working electrodes 114 is made of a dielectric.

Further, the clearance between the two working electrodes 114 is, for example, 15 μm or less. According to the above configuration, even when a minute foreign matter of about several tens of μm is present inside the housing (not shown) that houses the optical modulation device 100, it is possible to effectively prevent such minute foreign matter from forming a bridge on the working electrodes 114.

Further, the thickness of the first insulating layer 120 from the surface of the substrate 102 is 1 μm or more and 10 μm or less. According to this configuration, high controllability for the height of the first insulating layer 120 above the substrate 102 can be ensured when the first insulating layer 120 is made of resin.

Further, the difference between the height of the first insulating layer 120 and the heights of the two working electrodes 114 from the surface of the substrate 102 is 5 μm or less. According to this configuration, the height difference can be accurately set while ensuring the controllability of the height of the first insulating layer 120 on the substrate 102.

The optical modulation device 100 also includes a second insulating layer 122 covering a plurality of electrodes different from the two working electrodes 114 described above. According to this configuration, for electrodes that propagate DC or low-frequency electrical signals that are less affected by dielectric loss, these electrodes can be covered with the second insulating layer 122 to almost completely prevent the adhesion of foreign matter.

Further, the optical waveguide 104 includes two Mach-Zehnder optical waveguides 110 each including two parallel waveguides 112. A plurality of electrodes covered by the second insulating layer 122 are bias electrodes 130 used for adjusting the bias point of the Mach-Zehnder optical waveguide 110. According to this configuration, adhesion of foreign matter to the bias electrode 130 can be almost completely prevented.

Further, the second insulating layers 122 are formed as individual insulating layers separated from each other covering the respective bias electrodes 130 of the Mach-Zehnder optical waveguide 110. According to this configuration, interference (crosstalk) between the bias electrodes 130 between the Mach-Zehnder optical waveguides can be reduced.

Further, the first insulating layer 120 and the second insulating layer 122 are made of resin. According to this configuration, the first insulating layer 120 and the second insulating layer 122 can be easily formed thick to about 10 μm.

Further, the optical modulator 400 according to the third embodiment described above includes an optical modulation device 100 that modulates light, a housing 402 that houses the optical modulation device 100, an input optical fiber 414 that inputs light to the optical modulation device 100, and an output optical fiber 420 that guides the light output by the optical modulation device 100 to outside of the housing 402.

Further, the optical modulation module 500 according to the fourth embodiment described above includes an optical modulation device 100, the housing 402 that houses the optical modulation device 100, an input optical fiber 414 that inputs light to the optical modulation device 100, an output optical fiber 420 that guides the light output by the optical modulation device 100 to the outside the housing 402, and a drive circuit 508 that drives the optical modulation device.

Further, the optical transmission apparatus 600 according to the fifth embodiment described above includes the optical modulator 400 according to the third embodiment or the optical modulation module 500 according to the fourth embodiment, and a modulation signal generation part 608 which is an electronic circuit for generating an electrical signal for causing the optical modulation device 100 to perform a modulation operation.

According to these configurations, it is possible to achieve the optical modulator 400, the optical modulation module 500, and the optical transmission apparatus 600 with good characteristics and high reliability by preventing fluctuations in electrical characteristics due to adhesion of foreign matter in the housing 402 while securing the degree of freedom in designing the working electrode 114 and the like.

### REFERENCE SIGNS LIST

100, 100-1, 100-2, 100-3, 100-4, 100-5, 404 Optical modulation device
102, 102-1 Substrate
104 Optical waveguide
106a, 106b, 106c, 106d Side
107 Input waveguide
108a, 108b Nested Mach-Zehnder optical waveguide
110, 110a, 110b, 110c, 110d Mach-Zehnder optical waveguide
112, 112a, 112b, 112c, 112d, 112e, 112f, 112g, 112h Parallel waveguide
114, 114-3a, 114-3b Working electrode
114-1, 114-1a, 114-1b, 114-1c, 114-1d Signal electrode
114-2, 114-2a, 114-2b, 114-2c, 114-2d, 114-2e, 114-2f,
114-2g, 114-2h, 132a, 132b, 132c, 132b-1, 132a-1, 200 Ground electrode
118 Wiring electrode
118-1, 118-1a, 118-1b, 118-1c, 118-1d, 118-1e, 118-1f,
118-1g, 118-1h Signal wiring electrode
118-2, 118-2a, 118-2b, 118-2c, 118-2d, 118-2e, 118-2f,
118-2g, 118-2h, 118-2i, 118-2j, 118-2k, 118-2m, 118-2n, 118-2p,
118-2q, 118-2r Ground wiring electrode
120a, 120b, 120c, 120d, 120e, 120f, 120g, 120h, 120-1a,
120-1b, 120-2a, 120-2b, 120-3a, 120-3b, 120-3c, 120-4a, 120-4b,
120-4c, 120-5a, 120-5b, 120-5c First insulating layer
122a, 122b, 122c, 122d, 122e, 122f, 122a-1, 122b-1, 122c-1 Second insulating layer
126a, 126b Output waveguide
130, 130a, 130b, 130c, 130d, 130e, 130f, 130a-1, 130b-1 Bias electrode
142 Supporting plate
144a, 114b, 114c, 114d Protruding portion
150, 150a, 150b, 150c, 150d, 150e, 150f, 150g First stage electrode
152, 152a, 152b, 152c, 152d, 152e, 152f, 152g Second stage electrode
202 Buffer layer
400 Optical modulator
402 Housing
406 Relay substrate
408, 410 Signal pin
412 Terminator
414 Input optical fiber
416 Optical unit
418, 430, 434 Lens
420 Output optical fiber
422, 424 Support
500 Optical modulation module
506 Circuit substrate
508 Drive circuit
600 Optical transmission apparatus
604 Light source
606 Modulator drive unit
608 Modulation signal generation part

1. An optical waveguide device comprising:
a substrate;
an optical waveguide formed on the substrate;
an electrode for controlling a light wave propagating through the optical waveguide; and
a first insulating layer disposed between two adjacent electrodes among the electrodes, wherein
a height of the first insulating layer from a surface of the substrate is higher than heights of the two electrodes.

2. The optical waveguide device according to claim 1, wherein
the two electrodes are disposed at positions sandwiching the optical waveguide in a plane of the substrate.

3. The optical waveguide device according to claim 1, wherein
a clearance between the two electrodes is 15 μm or less.

4. The optical waveguide device according to claim 1, wherein
a thickness of the first insulating layer from the surface of the substrate is 1 μm or more and 10 μm or less.

5. The optical waveguide device according to claim 1, wherein
a difference between the height of the first insulating layer and the heights of the two electrodes from the surface of the substrate is 5 μm or less.

6. The optical waveguide device according to claim 1, wherein
the first insulating layer is resin.

7. The optical waveguide device according to claim 1, further comprising:
a second insulating layer covering a plurality of electrodes different from the two electrodes formed on the substrate.

8. The optical waveguide device according to claim 7, wherein
the optical waveguide includes two Mach-Zehnder optical waveguides each including two parallel waveguides, and
the plurality of electrodes covered by the second insulating layer form bias electrodes used for adjusting a bias point of the Mach-Zehnder optical waveguide.

9. The optical waveguide device according to claim 8, wherein
the second insulating layers are formed as individual insulating layers separated from each other covering respective bias electrodes of the Mach-Zehnder optical waveguide.

10. The optical waveguide device according to claim 7, wherein
the second insulating layer is resin.

11. An optical modulator comprising:
the optical waveguide device according to claim 1, which is an optical modulation device that modulates light;
a housing that houses the optical waveguide device;
an optical fiber that inputs light to the optical waveguide device; and
an optical fiber that guides light output by the optical waveguide device to outside the housing.

12. An optical modulation module comprising:
the optical waveguide device according to claim 1, which is an optical modulation device that modulates light;
a housing that houses the optical waveguide device;
an optical fiber that inputs light to the optical waveguide device;
an optical fiber that guides light output by the optical waveguide device to outside the housing; and
a drive circuit that drives the optical waveguide device.

13. An optical transmission apparatus comprising:
the optical modulator according to claim 11; and
an electronic circuit that generates an electrical signal for causing the optical waveguide device to perform a modulation operation.

14. An optical transmission apparatus comprising:
the optical modulation module according to claim 12; and
an electronic circuit that generates an electrical signal for causing the optical waveguide device to perform a modulation operation.
